(19) United States
(12) Patent Application Publication
(10) Pub. No.: US 2012/0249366 A1
(43) Pub. Date: Oct. 4, 2012

(54) COMMUNICATIONS ON THE MOVE ANTENNA SYSTEM

(75) Inventors: Jerome H. Pozgay, Marblehead, MA (US); David L. Hendry, Sudbury, MA (US); James Mcspadden, Allen, TX (US)

(73) Assignee: Raytheon Company, Waltham, MA (US)

(21) Appl. No.: 13/079,359

(22) Filed: Apr. 4, 2011

(51) Int. Cl. H04B 7/185

(52) U.S. Cl. 342/354

(57) ABSTRACT

Embodiments of the present apparatus and system are directed to a compact satellite communications on the move (SOTM) antenna system that maintains a communications link with a hybrid combination of mechanical and electronic beam steering. This hybrid system ensures that the antenna beamwidth in the plane of the geosynchronous satellites remains within internationally agreed to limits, independent of the location of the satellite with respect to the ground terminal. Systems constructed according to the principles presently disclosed also provide reduced antenna sidelobes in the satellite plane and minimize the electronic scan loss while simultaneously achieving controllable beamwidth, full field of view coverage, and low antenna height.

### FIELD OF THE INVENTION

This invention relates generally to satellite communication system terminals adapted for use in satellite communications on the move (SOTM) applications, in particular terminals using both mechanical and electrical beam steering of phased array antennas, and more particularly, systems using Active Electronically Steered Arrays (AESAs).

### BACKGROUND

A typical satellite communications (SATCOM) system includes, among other things, a transmit and receive antenna, antenna pointing control electronics of various types, radio frequency (RF) receivers and down-converters, and a baseband electronics suite that processes information received and prepares information for transmission. Such systems are further complicated when they are designed to be used from a moving vehicle of other platform. These latter systems are known as Communications on the Move (COTM) or SATCOM on the Move (SOTM) systems.

One conventional approach to SOTM is to mount the antennas on gimbals or other mechanical pointing devices that are controlled to track the satellite in its geosynchronous orbit. These systems are large and complex, requiring many mechanisms. In particular, they are often quite tall, which results in operational problems such as a lack of agility, concealability, and survivability.

Another conventional approach is to use phased array antennas with electronic beam steering. Phased array antennas include a plurality of antenna elements spaced apart from each other by known distances coupled through a plurality of phase shifter circuits to either or both of a transmitter or receiver. As is known, phased array antenna systems are adapted to produce a beam of RF energy and direct such beam along a selected direction by controlling the phase (via the phase shifter circuitry) of the RF energy passing between the transmitter or receiver and the array of antenna elements. In an electronically scanned phased array, the phase of the phase shifter circuits (and thus the beam direction) is selected by sending a control signal to each of the phase shifter sections. The control signal is typically a digital signal representative of a desired phase shift, as well as a desired attenuation level and other control data.

Phased array antennas are often used in both defense and commercial electronic systems. For example, Active Electronically Scanned Arrays (AESAs) are used in a wide range of defense and commercial electronic systems such as radar surveillance, terrestrial and satellite communications, mobile telephony, navigation, identification, and electronic counter measures. Such systems are often used in radar for land-based, ship and airborne radar systems, and satellite communications systems. Thus, the systems are often deployed on a structure such as a ship, aircraft, missile system, missile platform, satellite, or building where a limited amount of space is available.

Another requirement on SOTM systems is the need for sufficient antenna pointing and tracking agility to maintain communications link quality and availability with a given target satellite. In particular, such systems have to operate without interfering with neighboring satellites in the geosynchronous arc, i.e., those satellites stationed to either side of, and relatively near to, the target satellite. Not only is this undesirable from an operational standpoint, it is specifically prohibited by international treaty and national laws.

Known in the art today are numerous examples of agile SOTM antenna systems suffering from excessive antenna size (primarily height) and/or unacceptably large beamwidth in the plane of geosynchronous satellites. This latter drawback is especially significant because it results in RF interference and degraded communications to the satellite's neighbors in the geosynchronous orbit.

All known prior attempts to address these issues have resulted in systems with overly large visual signatures due to antenna height or systems that require special, complex waveforms to inhibit interference with neighbor satellites. In particular, it is well known that conventional low height SOTM solutions typically have very broad beamwidths (at least in one plane) that cause interference with other satellites over significant regions of the desired coverage volume.

What is needed is a compact, agile antenna system capable of satellite communications on the move without interfering with neighboring satellites. Such a system must also be simple and rugged for deployment in harsh environments.

### SUMMARY

In contrast to the above-described conventional approaches, embodiments of the invention are directed to a compact satellite communications on the move (SOTM) antenna system that maintains a communications link with a hybrid combination of mechanical and electronic beam steering. This hybrid system ensures that the antenna beamwidth in the plane of the geosynchronous satellites remains within internationally agreed to limits, independent of the location of the satellite with respect to the ground terminal. Systems constructed according to the principles presently disclosed also provide reduced antenna sidelobes in the satellite plane and minimize the electronic scan loss while simultaneously achieving controllable beamwidth, full field of view coverage, and low antenna height.

One embodiment of the invention is directed to an apparatus for communications on the move, comprising: a plurality of electronically-steered Active Electronically Scanned Arrays (AESAs) disposed on a mechanically-steered mounting platform, wherein the AESAs may be located with respect to one another so as to minimize self-interference, each of said plurality of AESAs having a main beam lobe; frequency conversion electronics operably connected to each of said antenna modules; and beam control electronics operably connected to said mechanically-steered mounting platform, said frequency conversion electronics, and to each of said plurality of AESAs, wherein said mechanically-steered mounting platform may be controlled by said beam control electronics to maintain directional pointing control to an azimuth selected with respect to a line-of-sight to a geosynchronous satellite; and wherein each of said plurality of AESAs may be electronically steered to maintain their respective main beam lobes essentially perpendicular to the geosynchronous orbital arc at the location of the geosynchronous satellite.

In a further embodiment, the apparatus may further comprise an inertial navigation system operatively coupled to said beam control electronics. In some embodiments, one or more of the plurality of AESAs may be a Ka-band receive AESA and/or K-band receive AESA and/or a Q-band transmit AESA. In some embodiments, at least one of said plurality of AESAs may be selectable between RHCP and LHCP.

In some embodiments, the beam control electronics may further comprise an antenna control unit (ACU), the ACU further comprising a programmed computer; one or more beam steering controllers, each operatively coupled to the ACU; and a mechanically-steered pedestal azimuth control means operatively coupled to the ACU.

In some embodiments, the apparatus may further comprise a beacon tracker operatively coupled to said beam control electronics, wherein the beacon tracker provides closed-loop tracking of a transponder signal. In some embodiments, the apparatus may further comprise modem tracking means operatively coupled to said beam control electronics and said frequency conversion electronics, wherein the modem tracking means provides closed-loop tracking of a received signal.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1A shows a SOTM terminal mounted on a vehicle according to one embodiment of the present invention.

FIG. 1B illustrates one embodiment of the SOTM terminal in perspective view.

FIG. 2 is a high-level block diagram of a SOTM terminal system according to one embodiment of the present invention.

FIG. 3A is a representative plot of antenna gain with respect to the theta angle to the satellite.

FIG. 3B is a representative k-space plot of the K-band antenna pattern.

FIGS. 4A and 4B represent a high-level schematic diagram of the SOTM terminal system according to an alternate embodiment of the present invention.

FIG. 5 is an exploded view of some of the internal components of a typical AESA as employed in the present invention.

FIG. 6 illustrates the relative mounting and pointing angles of the AESA antenna in an exemplary embodiment of the present invention.

### DETAILED DESCRIPTION

Embodiments of the present system are directed to systems for employing same to provide a controllable, steerable uplink and downlink between a mobile ground terminal and a designated satellite using multiple hybrid scanned Active Electronically Scanned Arrays (AESAs). The hybrid scanned antenna system uses a combination of mechanical and electronic beam steering to ensure that the beamwidth in the plane of the satellite's orbit remains within internationally agreed to limits, independent of the location of the satellite with respect to the ground terminal. The technique also reduces antenna sidelobes in the satellite plane and minimizes the electronic scan loss.

AESAs are preferable for the antenna apertures because they provide inertialess beam steering capability, permitting the optimization of antenna pointing with regard to its physical and electrical limitations—high angular beam steering rates due to rugged conditions of battlefield terrain do not present a system limitation as they do for prior-art mechanically gimbaled antenna systems. AESA front-end RF losses are low, maximizing G/T and EIRP, hence data rate, for a given aperture size. Interference with and from adjacent satellite services is readily controlled by electronic control rather than by spatial shaping as is done with reflector antennas. Visual signature is also reduced through beam agility. Reliability, hence service availability, is increased through the graceful degradation provided by inherent redundancy in the elements of the AESAs.

AESA-based antenna systems have certain drawbacks that are overcome in the present system. As with many phased-array antennas, AESAs may present beam scan loss due to aspect and scan dependent mismatch and depolarization at very large scan angles. Furthermore, the presence of multiple apertures operating at the same time (either receiving multiple beams, transmitting in multiple bands, or both) can result in self-jamming. And, as in any compact packaging of powerful transmitters, thermal management of the distributed heat sources must be addressed. The present system addresses and overcomes each one of these challenges. Here, the low-torque hybrid scanning system mechanically positions the AESAs for an optimum beam pointing geometry that minimizes electronic scan and reduces sidelobes in the plane of the geosynchronous satellite. The hybrid scanning system also ensures that transmit apertures are never focused toward the receive aperture, thus eliminating the risk of over-driving the receive low-noise amplifiers (LNAs).

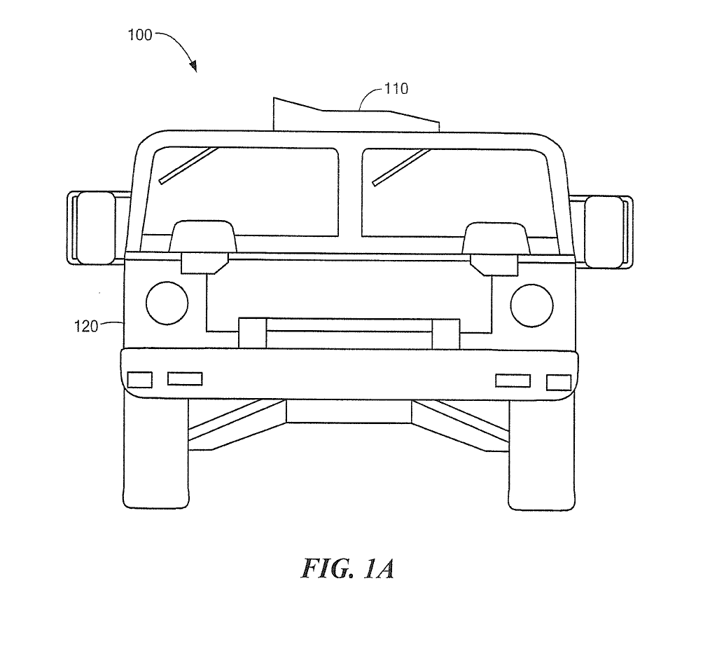

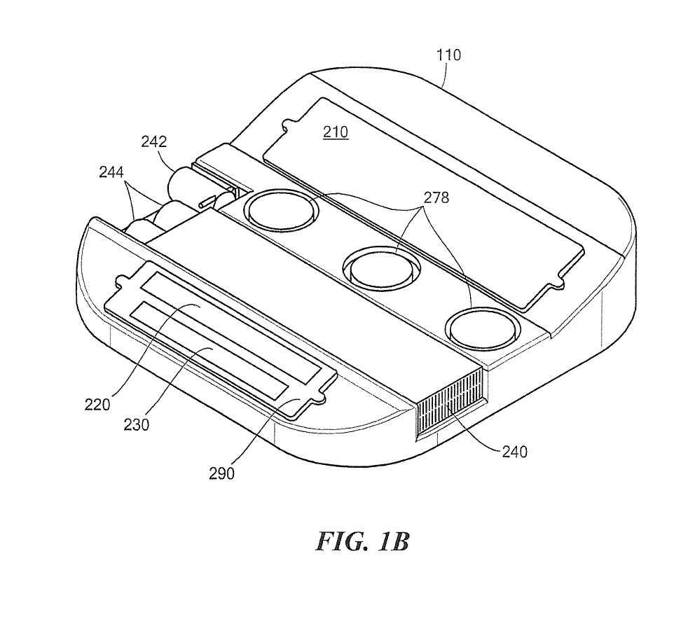

FIG. 1A depicts an embodiment of an AESA-based, vehicle-mounted SOTM terminal comprised of three AESAs, one dedicated to each of the K-, Ka-, and Q-bands (further described below by reference to FIG. 1B). The three AESAs may, in some embodiments, be mounted in a low-torque rotating housing 110 to provide a hybrid electronic/mechanical scan. The rotating housing may employ tilted array faces to provide low elevation coverage while reducing the number of radiators relative to the number required to simultaneously achieve coverage and satellite service interference goals using only electronic scan. Housing 110 is in turn mounted (via a mechanical azimuth positioning mechanism (not shown) on vehicle 120.

AESAs are more completely described in U.S. patent application Ser. No. 12/757,371, filed on Apr. 9, 2010, and incorporated herein by reference in its entirety.

As will be apparent to one of ordinary skill in the phased array arts, AESAs may come in many forms, including but not limited to those utilizing embedded circulators; slot-coupled, polarized egg-crate radiators; single integrated monolithic microwave integrated circuits (MMICs); and/or passive RF circuit architectures. For example, technology described in the following commonly assigned United States Patents can be used in whole or in part and/or adapted to be used with at least some embodiments of the antennas and arrays described herein: U.S. Pat. No. 6,611,180, entitled “Embedded Planar Circulator;” U.S. Pat. No. 6,624,787, entitled “Slot Coupled, Polarized, Egg-Crate Radiator;” U.S. Pat. No. 6,731,189, entitled “Multilayer Stripline Radio Frequency Circuits and Interconnection Methods;” U.S. Pat. No. 7,348,932, entitled “Tile Sub-array and Related Circuits and Techniques;” and U.S. patent application Ser. No. 12/484,626, entitled “Panel Array,” filed on Jun. 15, 2009. Each of the above patents is hereby incorporated herein by reference in their entireties.

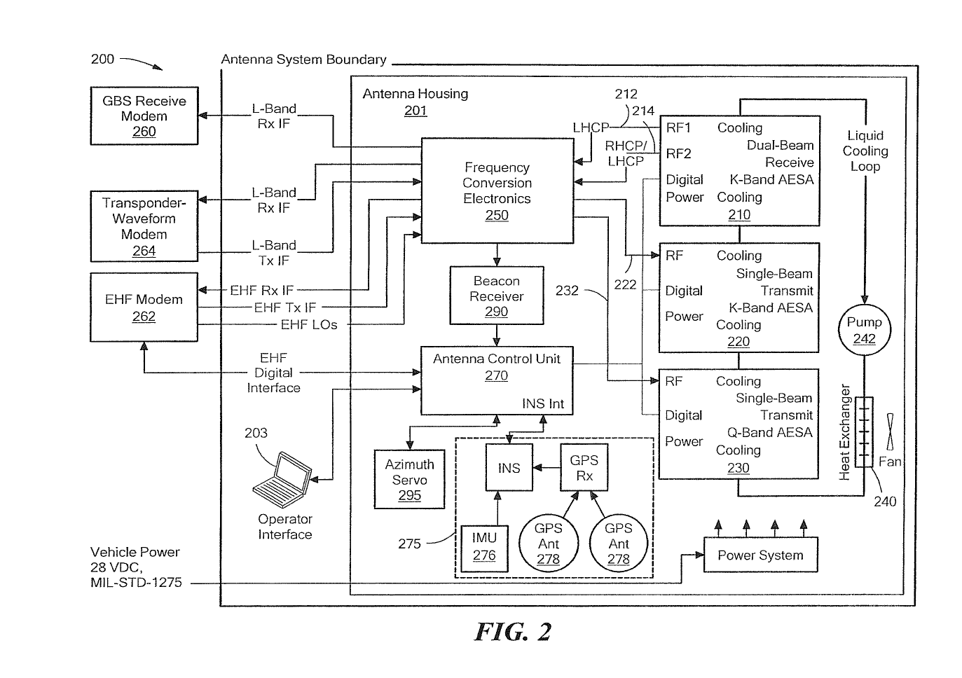

The top-level block diagram of FIG. 2 depicts terminal system 200 in block diagram form. Terminal system 200 may comprise antenna housing 201 and operator interface 203. Within antenna housing 201, in one exemplary embodiment, are three AESA apertures: a dual-beam K-band receive aperture 210, a single-beam Ka-band transmit aperture 220, and a single-beam Q-band transmit aperture 230. Each of AESA apertures 210, 220, and 230 are phased arrays of elements, further described below. For this reason, the apertures are also individually referred to herein as “arrays.”

In some embodiments, the apertures may be liquid-cooled in series with liquid-to-air heat exchanger 240, pump 242, and one or more fans 244 (also shown, in one embodiment of a range of potential mechanical packaging configurations, in FIG. 1B) dissipating waste heat to the environment. The K-band receive array 210 has two RF output ports 212 and 214, one selectable between RHCP and LHCP, the other LHCP-only. These RF output ports, along with the RF input ports 222 and 232 to Ka-band transmit array 220 and Q-band transmit array 230, respectively, connect to frequency conversion electronics 250. This exemplary frequency conversion approach supports one receive-only modem 260 simultaneously with either a full-duplex EHF modem 262 or a full-duplex transponder-waveform modem 264. The modems may interface to frequency conversion electronics 250 using standard IF frequencies, such as, but not limited to, L-band. In addition, EHF modem 262 provides the set of Local Oscillator (LO) signals required to perform hopping and dehopping, as well as an 80 MHz frequency reference for use within frequency control electronics 250.

Although a representative frequency conversion architecture is described herein, those skilled in the art will realize that various frequency conversion schemes, as well as frequency plans, other than those presently described can be employed to the same ends. Accordingly, the concepts, systems, and techniques described herein are not limited to any particular frequency plan or frequency conversion approach.

Antenna Control Unit (ACU) 270 provides pointing angles to each array 210, 220, and 230 via a digital interface. ACU 270 interfaces to Inertial Navigation System (INS) 275, which comprises an Inertial Measurement Unit (IMU) 276, Global Positioning System (GPS) receiver 277, and one or more GPS antennas 278. ACU 270 performs antenna pointing, stabilization, and tracking calculations and communicates through operator interface 203 for user control. In an exemplary embodiment, operator interface 203 may be provided by a laptop computer. The details of operator interface 203 and the internal structure of ACU 270 are discussed further below.

Beacon receiver 290 is used for closed-loop tracking on transponder satellites; the EHF modem 262 may be used as a substitute for beacon receiver 290 for EHF SATCOM links. When K-band receive array 210 is pointed to two different satellites, tracking is performed simultaneously on each. Transmit pointing is slaved to receive pointing. ACU 270 also controls the azimuth servo system 295 that keeps antenna housing 201 (and thus arrays 210, 220, and 230 mounted therein) properly oriented to the equatorial plane.

In some embodiments, all antenna backend components (e.g., frequency conversion electronics 250, ACU 270, beacon receiver 290, INS 275, etc.) may be miniaturized and integrated within rotating antenna housing 201. One of ordinary skill in the art will readily appreciate that such miniaturization and packaging efforts, including thermal management and hostile environment protection, may be addressed by various techniques well known in the MIL-SPEC packaging and design arts. Accordingly, except as noted below, these aspects will not be further described.

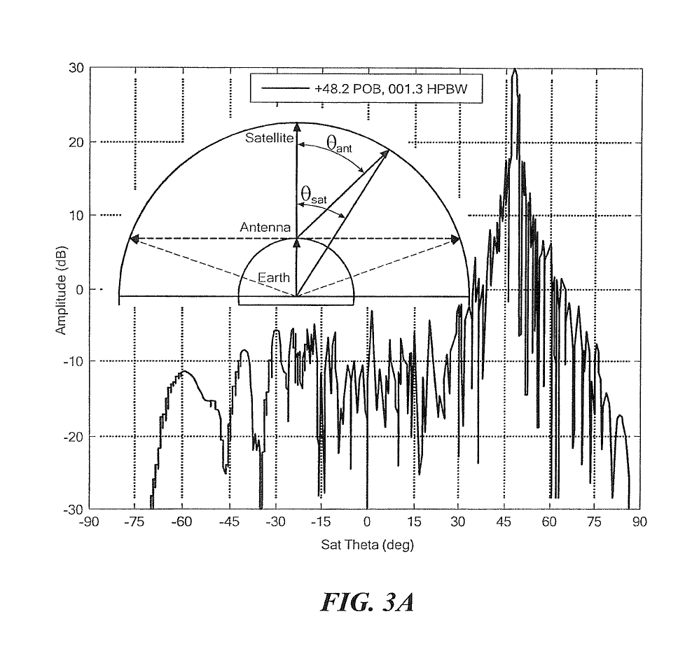

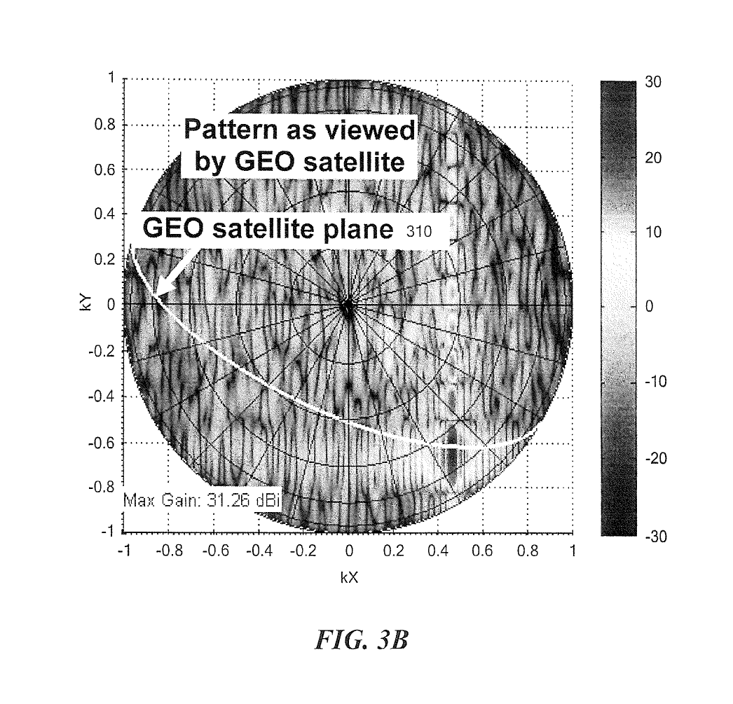

AESAs are preferred for apertures 210, 220, and 230 because they can be packaged into a space-efficient, high-aspect ratio rectangle, resulting in an advantageous, simultaneous orientation of each aperture to the geosynchronous orbital plane. Since the beamwidth is narrowest parallel to the long dimension of each array, the optimum orientation of each array has its long dimension parallel to the equatorial plane. FIGS. 3A and 3B illustrate this geometry for the K-band receive AESA array. FIG. 3A is a representative plot of antenna gain with respect to the theta angle to the satellite, FIG. 3B is a representative k-space plot of the K-band antenna pattern in antenna coordinates. The geosynchronous (GEO) orbit plane 310 is indicated, showing that the maximum gain region of the array is approximately perpendicular to the GEO plane.

However, achieving proper beam orientation in the GEO plane requires mechanical rotation of the arrays. It is important to note that this mechanical rotation need not achieve the high accelerations and velocities implied by typical dynamics models for moving platforms; the orientation relative to the equatorial plane need only be approximately correct and follow the slower, larger excursions of vehicle heading (i.e., turning). The full-range fast electronic scan capability of the arrays themselves, rather than the mechanical rotation, achieves the precise pointing required to minimize transmit and receive RF losses.

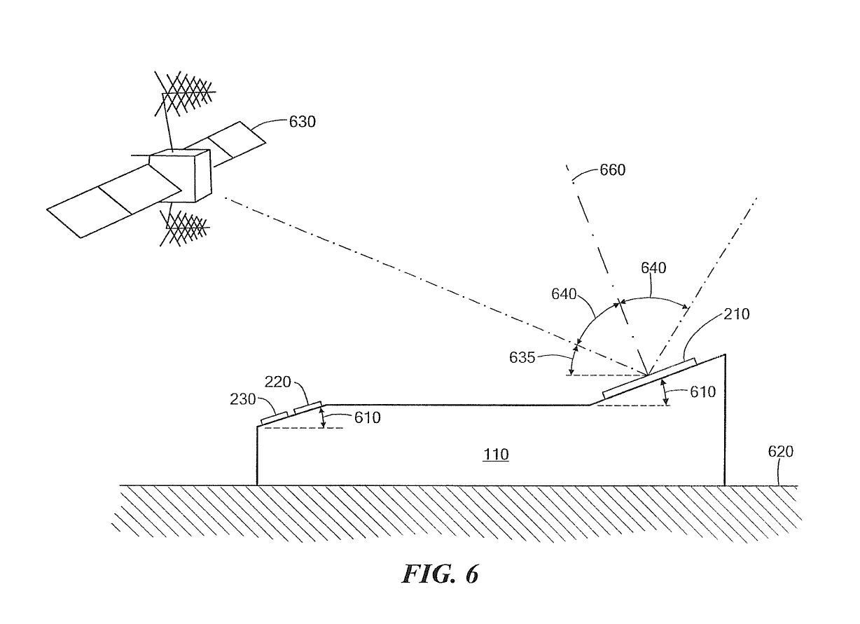

Once mechanical rotation is combined with the electronic beam steering capabilities of the AESA in a hybrid pointing technique to minimize the beamwidth in the GEO plane, canting each aperture relative to vertical achieves another significant advantage. In one exemplary embodiment, shown as a side view of housing 110 in FIG. 6, each aperture 210, 220, and 230 is canted by 27.5° (angle 610) relative to rooftop normal 620 (i.e., local horizontal relative to the vehicle or other platform upon which the terminal is mounted). With this cant, communications with a satellite 630 an elevation angle of 20° (angle 635) requires each array to scan to only 55° (angle 640) from the normal 660 to the antenna face 210 (illustrated on the K-band antenna 210 only, for clarity) instead of 70°. This significantly reduces scan loss and scan-induced depolarization, making each array smaller, lighter, lower in cost, and consuming less power as well as improving axial ratio.

Although a cant angle of 27.5° is described, one of ordinary skill in the art will readily appreciate that the selection of the proper cant angle is dependent on the tradeoff parameters specific to the particular mission needs of the system. Other embodiments may use a different cant angle, such as (but not limited to) 20°, the determination of which is well-within the skill of an ordinary practitioner guided by this disclosure. Accordingly, the present invention is not limited to any particular cant angle 610.

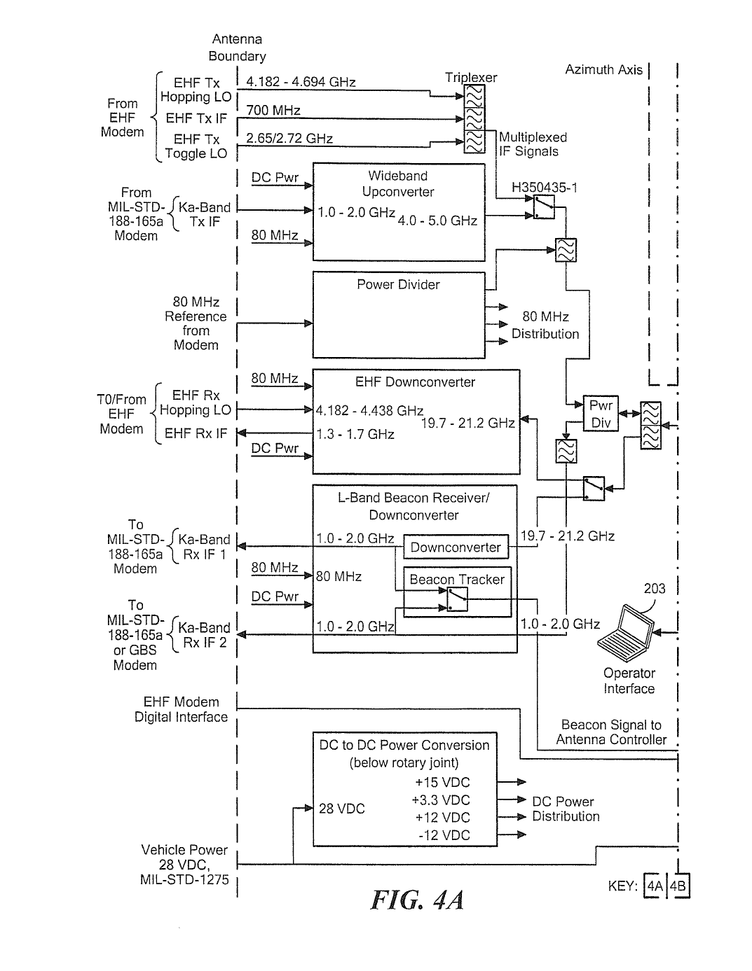

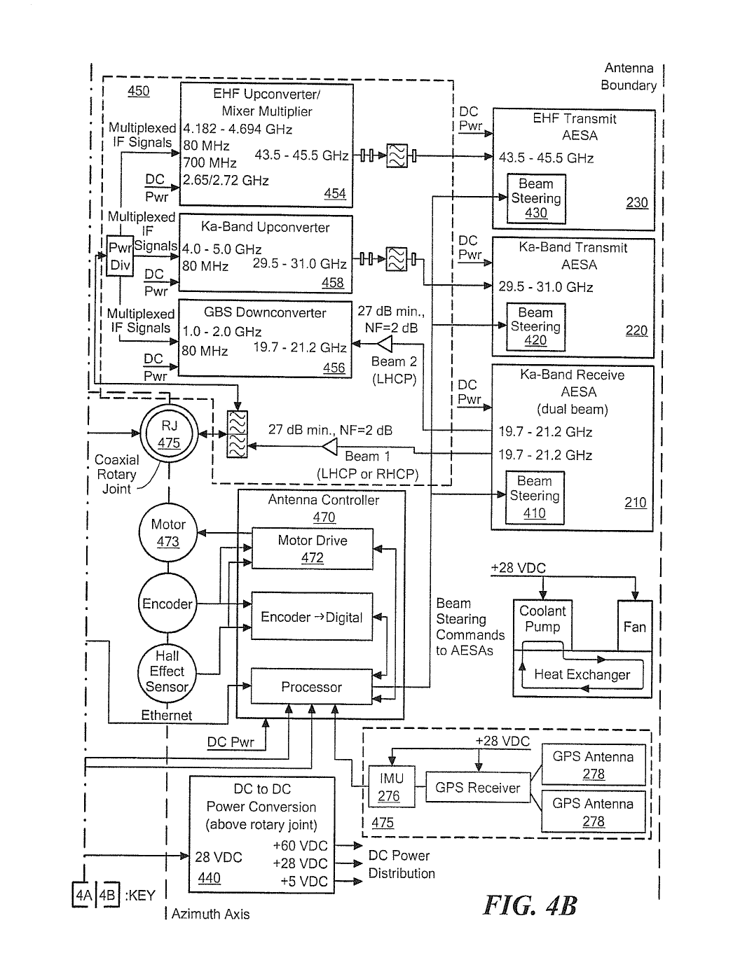

Although the antenna is generally referred to as an AESA, one familiar with this technology will appreciate that the antenna assembly comprises more than the AESA array alone. Indeed, each antenna 210, 220, 230 (referring to FIGS. 4A and 4B) may comprise, in addition to the AESA, one or more beam steering controllers (BSCs) 410, 420, and 430, respectively, a digital receiver/exciter including a fundamental frequency reference (not shown but part of each AESA), one or more power supplies 440, and a radome providing protection from the external environment (not shown for clarity of illustration). Frequency conversion electronics 450 may include, in some embodiments, a set of hopping upconverters and downconverters 454 for EHF, one or more K-band block downconverters 456 and a Ka-band block upconverter 458.

In some embodiments, Ka- and Q-band transmitting apertures 220, 230 may be enclosed in an enclosure 290 (see FIG. 2) to provide RF and intermediate frequency (IF) isolation from the K-band receive aperture 210. In such a compartmented system, a single beam steering controller (BSC) located within the isolation enclosure may control both of the transmit arrays, since only one is active at a time. In such an embodiment, K-band receive array 210 will necessarily have its own dedicated BSC. Alternatively, ACU 270 may provide all necessary beam steering control by incorporating all of the BSC functions.

As used herein, the term “beam control electronics” is to be understood to refer collectively to the dedicated K-, Ka- and Q-band BSCs 410, 420, and 430 and ACU 470 that together provides all necessary electronic and mechanical beam pointing functionality. The beam control electronics (which may be provided by a distributed set of discrete modules as shown in FIGS. 4A and 4B or in a single integrated device, without limitation) provide command and control of the individual transmit/receive assemblies in the antenna array to provide for quick and agile beam steering. At essentially the same time, the beam control electronics also command motor 473 to maintain the necessary azimuth pointing of the turntable mount.

In one exemplary embodiment, the beam control electronics may accept pointing commands comprising two phase slopes (azimuth and elevation) and a frequency instruction. The beam control electronics generally (and ACU 470 in particular) may use this input along with internal, non-volatile memory based calibration tables (discussed below) to calculate the individual phase settings and update the array BSC (when present) accordingly to point the beam in the direction commanded. Typical update rates for comparable systems may range from approximately 25 to 100 microseconds, most of which is typically loading the new states to the BSCs. Once all the data has been loaded, a single global trigger to all the BSCs in parallel may result in the updated beam state being transferred to the BSCs. In this way, the actual RF beam transition may be accomplished in the order of 10 nanoseconds.

An AESA may be constructed from a number of Transmit or Receive Integrated Microwave Modules (TRIMMs), each of which may contain multiple transmit/receive elements. The construction of a TRIMM may involve the direct die-attach of integrated transmit/receive MMICs to a soft-substrate microwave printed wiring board (PWB), or may involve the mounting of drop-in prepackaged integrated transmit/receive MMICs to a PWB. The RF manifold is typically embedded in the PWB. In some embodiments, the antenna elements may also be embedded in the PWB. In one embodiment, a copper thermal plane is bonded to the back of the board, thereby forming an integrated RF/DC/logic/thermal management TRIMM assembly, to transfer heat to a cold plate or similar thermal radiator without limitation, although other heat dissipation methods will be readily apparent to those of skill in the arts.

In particular, K-band receive antenna 210 may be comprised of a high aspect ratio rectangular aperture with elements arrayed on a stable base triangular grid. Each element may comprise a radiator, an LNA, a phase shifter, and associated RF, DC, and logic circuitry. From the radiator to the RF summing point, electronics and beam forming networks may be integrated on a single Receive Integrated Microwave Module (RIMM).

In a typical SOTM application, size, cost, G/T, and beamwidth are the critical parameters for a K-band aperture design. In order to reduce scan loss for a SOTM ground terminal operating over severe terrain at any earth location for which the apparent satellite elevation is greater than 20 degrees above the horizon, a 27.5° elevation angle for the aperture face from local horizontal may be used. (See FIG. 6) This embodiment advantageously results in reduced electronic beam scanning requirements, which (in turn) keeps the element count low—e.g., meeting this G/T requirement with an array parallel to the local horizontal would require at least 800 more elements. The tilt angle was carefully analyzed with respect to the packaging of the transmit arrays to avoid any blockage between the apertures. The 27.5° tilt angle 610 was selected to keep the height of the antennas and their supporting hardware less than 6 inches in order to minimize the visual signature of the terminal. Also supporting the decision to tilt up the antenna is the need to maintain the antenna beamwidth at ≦2.5° along the geosynchronous orbital plane in order to avoid receiving interference from neighboring satellites. (The orbital spacing of 2.5° between satellites in GEO is set by international convention.) The beamwidth requirement of ≦2.5° may thus be met with a long, rectangular shaped aperture on a rotating platform that is mechanically turned to keep narrow portion of the fan beam pattern approximately perpendicular to the satellite plane.

In a terminal system embodiment having two independently-steered beams designed for military SOTM applications, the maximum scan angle is dictated by the satellite orbit locations of Global Broadcast System (GBS) and Wideband Global SATCOM (WGS) satellites. Analysis has revealed that a 55° angle is an appropriate maximum scan angle needed to communicate with these systems. With these considerations, 1008 receive elements are needed in the array to maintain a minimum of 7 dB/K at 27.5° elevation angle. The array length has 72 elements to achieve the beamwidth requirements, and the array width has 14 elements to meet the 7 dB/K G/T.

Thus, the K-band array may be configured as a 14×72 element design containing a total of 28 RIMMs for a total population of 1008 elements. The element spacing is 0.311″ (along RIMM)×0.270″ (card to card) on a triangular lattice. Each element unit cell has a feed structure on the RIMM card that engages into the dielectrically loaded waveguide cavity within the aperture plate to achieve the circular polarization requirements of the aperture. This interface along the front edge of the RIMM provides for both the RF grounding of the radiators and a low loss stripline to waveguide transition,

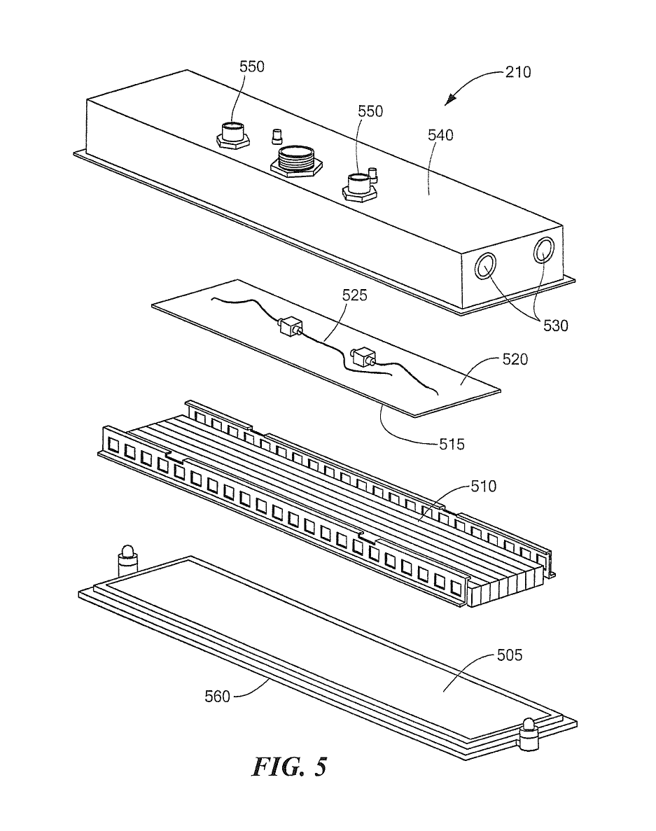

The exploded view of FIG. 5 in shows some of the components of an exemplary K-band AESA. For ease of illustration, the component stack is shown upside-down from its typical mounting. In other words, a low vapor permeable Wide Angle Impedance Matching (WAIM) screen assembly 560 (not visible) is the top-most component and forms the upper-most surface of aperture 505. RIMM assemblies 510 located below the aperture plane include RF/DC/logic/thermal management distributions along the plane of the RIMMs. DC distribution manifold and beam steering controller assembly 515 is located on the top (hidden) side of mid structure plate 520. Opposite DC manifold and BSC 515 is RF power combiner manifold assembly 525. Finally, environmentally sealed housing 540, including one or more integral desiccator assemblies 530 (to capture stray moisture) and interface connectors 550, encloses all of the components for protection from the elements.

Internal flex circuits and interconnects are not shown for clarity. The array may be assembled starting from the aperture cold plate 505 with progressive assemblies mounting onto it. The entire assembly 210 can then drop into antenna housing 110 (referring to FIG. 1B) to form an environmentally sealed system with desiccants for humidity control.

Although a particular mechanical packaging design approach for a receive AESA has been described, those skilled in the art will realize that various AESA packaging design approaches can also be used in addition to or instead of the present approach. Accordingly, the concepts, systems, and techniques described herein are not limited to any particular type of AESA packaging. Furthermore, while this design approach is illustrated with respect to the receive array, it is equally applicable (with the same alternatives) to the transmit arrays.

Similar to the K-band receive antenna 210, the Ka-band transmit antenna 220 embodiments may be driven by size, cost, and beamwidth. Additionally, EIRP, DC power, and sidelobe levels may also be employed as parameters in the trade space. In some embodiments, the Ka-band antenna may be designed towards an exemplary EIRP requirement of 47 dBW at a 20° elevation angle. This leads to the same tilt up angle of 27.5° to avoid blocking receive array 210 and reside within the 6″ height requirement. Since the antenna beamwidth requirement is again ≦2.5° along the geosynchronous satellite plane, the aperture is rectangular and mechanically rotated to keep narrow portion of the fan beam pattern along the satellite plane. Because the transmit beam operates by following one of the two receive beams, the maximum scan angle is again 55°. The last major constraint on the transmit array size is the pattern mask requirement given in MIL-STD-188-164A along the satellite plane. In one exemplary embodiment, reconfiguring the uniformly illuminated rectangular aperture as a regular parallelogram with short sides making angles of 60 and 120 degrees relative to long sides allows us to meet this requirement without the expense of antenna gain loss and output power increase typical of illumination tapering approaches for sidelobe reduction. With these considerations, 608 (only 576 of which are active) transmit elements are needed to maintain a minimum of 47 dBW at a 20° elevation angle under typical dynamic conditions. The Ka-hand array has 76 elements in the long dimension to meet the beamwidth requirement. However, only eight rows of these elements are needed to meet the 47 dBW EIRP at a 55° scan angle.

In this exemplary embodiment, the key requirements on the Q-band transmit array 230 design, excepting sidelobe performance, are identical to the Ka-band transmit array 220 and the same trades may be performed. Meeting an exemplary EIRP requirement of 47 dBW at a 20° elevation angle results in mounting Q-band array 230 at the same 27.5° tilt up angle as Ka-band array 220. Ka-band array 220 and Q-band array 230 are also located at the far edge of the antenna housing (relative to K-band receive array 210) to increase their physical separation from K-band receive array 210. As the EIRP, beamwidth, and axial ratio requirements are similar to those imposed on the Ka-band array, the Q-Band AESA illumination is uniform.

Adaptation of each of the antenna arrays described to other operating parameters (frequency, EIRP, beamwidth, etc.) is well within the skill of practitioners in this field. Accordingly, this invention is to be understood as not limited by the specific design of the AESAs described herein as the concepts disclosed are applicable to any type of phased array antenna mounted on a mechanically steered platform.

As noted above, Ka-band and Q-band transmit antennas 220 and 230 may be packaged together in a single isolation housing 290 (referring to FIG. 1B). As described above, each array is populated with Transmit Integrated Microwave Modules (TIMMs) as the building block. The Q-band array contains 16 TIMMs, each having 36 elements, for a total population of 576 elements. The element spacing is 0.145″ along a TIMM×0.126″ (card to card) on a 60 degree triangular lattice. The Ka-band array architecture is similar, having 38 elements per TIMM, with element spacing 0.213″ along a TIMM×0.184″ (card to card) on a 60 degree triangular lattice. The packaging and interfaces for the arrays are similar to those for the K-band receive array discussed previously.

AESAs 210, 220, and 230 need to be individually calibrated to ensure accurate pointing. The calibration may comprise measuring the phase and amplitude response for each of the individual communications channel as a function of phase state within an array. The data is used to create calibration tables that compensate for channel-to-channel variations resulting from the manufacturing process. The tables are a function of frequency and temperature and are stored in non-volatile memory in the beam control electronics. This calibration is performed using standard phased array test and measurement techniques for a beam orthogonal to the face of the array.

Once each of the arrays has been calibrated, a boresight alignment is also performed using standard phased array test and measurement techniques. The array mounting fixture is carefully aligned to the range using very accurate optical alignment tools and procedures. The array is then steered to maximize the measured signal. The resulting beam position delta relative to the broadside setting is considered a pointing error and is stored in non-volatile memory within the beam control electronics. This error is typically removed as part of the beam pointing algorithm through a process well known in the art. Maintaining tight mechanical tolerances of the array mounting locations in the system will ensure transmit to receive beam alignments. Additional measurements at the system level to verify the installed beam alignment may be made to further refine the calibration tables, again using standard test and measurement techniques.

The other major component of the terminal system is the mechanical mounting and azimuth drive subsystem used to provide the mechanical steering of the antennas. In one exemplary embodiment, the azimuth drive may incorporate a conventional brushless DC motor coupled to provide direct drive on axis. Such a motor may be a frameless pancake type design such as those made by Kollmorgen Corporation. It is important to note that azimuth drive need not achieve the high accelerations and velocities implied by typical dynamics models for on the move systems. The function of the azimuth drive, correctly orientating the long dimension of the arrays parallel to the equatorial plane, need only be approximately correct and follow the slower, larger excursions of vehicle heading (i.e., turning). The full-range, fast electronic scan capability of the arrays themselves, rather than the mechanical rotation, achieves the precise pointing required to minimize transmit and receive RF losses This makes the design of the azimuth drive system much less demanding than it would be in a conventional mechanically pointed system.

Key characteristics of the major drive and structure components according to one embodiment of the present invention include the following elements, illustrated in FIGS. 4A-4B. Of course, various mounting and mechanical packaging systems can also be employed without undue experimentation by persons of ordinary skill in the arts. Accordingly, the present systems and techniques are not limited by a particular mechanical configuration.

Azimuth drive system 472 comprises, in one exemplary embodiment, a pair of 20-in. pitch diameter angular contact bearings arranged in a double back (DB) configuration and a direct drive using a frameless pancake brushless DC motor 473. Slip ring/rotary joint 475, comprising, for example, a 45-channel pancake style slip ring and one or more RF rotary joints assemblies carries RF, IF, and DC signals from the fixed to the moving side of the turntable.

An array support structure (housing 110, FIG. 1B) may be provided by an aluminum structure for supporting the apertures and electronics above the azimuth bearing. The stiffness and weight of the array support structure may be conventionally designed and constructed to accommodate the desired servo bandwidth of the turntable by means well known in the art.

Finally, a fixed azimuth support structure between housing 110 and vehicle 120 (also referred to generally as a pedestal) comprises, in one exemplary embodiment, an aluminum structure below the azimuth bearing that supports the moving turntable. Again, the stiffness and weight of the azimuth support structure may be conventionally designed and constructed to accommodate the desired servo bandwidth of the turntable.

The array support housing 110 is vented through a desiccant filled pressure relief valve located in the I/O panel, which is mounted flush with the bottom of the unit and includes connectors for power and signal from external units located within vehicle 120. This provides for pressure equalization in housing 110 over the expected temperature excursions. Placing the valve in the I/O panel penetration into vehicle 120 minimizes the amount of liquid water that could be ingested and would have to be absorbed by the desiccant, thereby reducing its life.

Pointing and tracking of the antennas is accomplished using common approaches seen in implementations of naval shipboard terminals that also track very narrow beamwidth antennas on both EHF and transponder satellites. IMU 276, mounted on or in housing 110, provides nearly instantaneous measurements of angular rates that allow antenna beam pointing to be stabilized against motion. This sensor is always used during both acquisition and tracking.

A low cost GPS-based INS 475 may also be employed to provide the heading, pitch, and roll angles of the vehicle during initial acquisition of the satellite signal. IMU 276 may be part of INS 475. INS 475 enables initial acquisition of the satellite while the terminal is moving.

After acquisition, the system takes advantage of the rapid electronic scan capability of the K-band receive array to perform closed loop tracking. Because closed-loop tracking is used after acquisition, the system can accept the lesser accuracy of a low-cost INS system. The accuracy of the heading, pitch, and roll estimates from the INS only affect the initial acquisition and not the pointing accuracy after acquisition is complete.

Initial acquisition time is in part determined by the number of spatial cells that must be searched. This is in turn a function of the receive antenna beamwidths and the accuracy of the initial pointing calculation. Initial pointing accuracy depends on the accuracy of the information about the antenna's orientation (from the INS), location, satellite ephemeris, and antenna system errors. In this case, ephemeris and orientation errors will dominate. Analysis indicates that a 1° search window, equal in azimuth and elevation, is sufficient to account for the ephemeris error of an EHF satellite; less is required for WGS satellites. Attitude errors of 0.5° are achievable in a low cost INS systems (e.g., systems such as Pinpoint by Enpoint LLC of Waltham, Mass.). Even with this combined error, the minimum elevation beamwidth (the short dimension of the rectangular array) is sufficiently wide (7.5°) to preclude the need for an elevation search. With a minimum azimuth beamwidth of 1.5°, a two-cell spatial search may be required at high elevation angles. For WGS acquisition, the system combines this with a beacon frequency search to account for the maximum beacon frequency error specified for WGS, +/−270 KHz. Based on this analysis, searching 108 frequency windows each 5 KHz wide will be sufficient. Thus, the maximum combination of frequency and spatial search cells is 216. Based on this, and accounting for the lower G/T of this antenna, a dwell time of 100 msec per cell is sufficient to provide an overall probability of correct detection of 0.99 and a probability of false detection of 0.001. Typical start-up times for GPS-based INS systems are 1 minute or less resulting in a total time of well under 2 minutes for initial acquisition.

EHF acquisition differs in that a frequency search is not required but a time search is. It also differs in the fact that the EHF modern, which is not part of the antenna system, substitutes for the beacon receiver, which is part of the antenna system. As a result, acquisition time is not entirely under the control of the antenna system.

After acquisition is complete, the system no longer relies on the heading, pitch, and, roll estimates from INS 475. Instead, it continues to use IMU 276 to sense the angular rates of the vehicle and stabilize antenna pointing against motion. Closed-loop tracking is used to minimize the residual errors in pointing and to correct for the long-term drift of the angular rate sensors. This approach is identical to that which has been proven on a number of other moving platforms (ships and airplanes) with narrow beamwidth antennas.

For initial acquisition on a transponder satellite, the system uses the downlink beacon to acquire when no communication channel is present. However, once the terminal is processing a communications channel, the system switches to tracking on the communications channel itself rather than the beacon. This is done because of the potentially large frequency separation between the beacon and the communication channel. Because the AESA uses phase shifters rather than true time-delay units, its pointing angles have a dependency on frequency. Trying to simultaneously process a communications channel and a beacon widely separated in frequency would result in a pointing angle difference between the two of them, complicating the tracking algorithm and possibly degrading performance. Tracking on the communications channel avoids this problem altogether. Accordingly, the system includes this capability in the beacon receiver. On EHF, downlink synchronization hops substitute for the beacon and the system both acquires and tracks using these hops. Although EHF hops over a wide bandwidth, it does not present a frequency separation-derived pointing angle difference issue similar to that described above since the terminal processes only a single, relatively narrow beamwidth carrier at any given time. A hop frequency interface to the modem allows the pointing angles to be compensated for beam squint over the hopping bandwidth.

In both the transponder and EHF cases, tracking relies on the rapid electronic scan capability of the AESA. Here, AESAs realize major advantages over mechanical scanning in tracking performance. The first advantage is particularly important for SOTM terminals. The antenna can be electronically scanned up and then down or left and then right in rapid succession. By making two complementary measurements within a short time relative to the decorrelation time of the channel due to the fading and blockages typical of SOTM links, the sensitivity of the tracking loop to these effects is virtually eliminated. Also, these measurements may be taken in a short span of time relative to vehicle motion. As the antenna scans to stabilize its beam pointing in response to changes in vehicle attitude, changes in both the beamwidth and the gain of the antenna will result. By making complementary measurements in rapid succession, the effects of these changes are virtually eliminated as well. These advantages apply both to transponder and EHF SATCOM.

There are additional advantages that apply only to EHF SATCOM. By making complementary measurements in the first and second halves of a single frequency hop, the effect of signal level ripple over the frequency band is eliminated. This ripple, the combination of satellite EIRP ripple over the hopping band and terminal G/T and gain ripple, may be significant: analysis has shown it to be by far the largest source of noise variance in a tracking loop that uses only mechanical scanning. In addition, antenna pointing can be offset only during synchronization frequency hops so that there is no squint loss from scanning during frequency hops used for data.

The minimum G/T of this system is about 10 dB less than similar terminals, which increases the noise variance at the input to the tracking loop, but this is compensated by a correspondingly wider antenna beamwidth. Dynamics of a vehicle may be more severe than shipboard motion, but this is offset by speed of electronic scanning compared to a conventional mechanical scan approach. For uplink tracking performance, this system has a major advantage compared to other terminals in that there is no squint loss from tracking on the uplink. Pointing alignment of the arrays will contribute to uplink pointing loss (similar to co-boresight error on a reflector antennas), however, this is mitigated by the relatively large beamwidths of the transmit arrays.

In one exemplary embodiment, the apertures may be mounted on a rotating platform, also referred to herein as a turntable. This turntable, combined with a 27.5° cant in the mounting angle of the apertures from vertical, extends coverage down 20° elevation without excessive scan loss that would have to be compensated by an increase in array size. Also, the turntable, by orienting the broad dimension of the array parallel to the equator, minimizes the beamwidth of the antennas in the geosynchronous satellite plane. It is important to note that the turntable need not be designed to track to the high acceleration and velocity levels of the vehicle—that is accomplished by the electronic beam steering of the arrays. The turntable tracks the longer term changes in vehicle heading to keep the arrays pointed approximately in the direction of the geosynchronous plane.

As noted above, in EHF systems, the functions equivalent to those performed by the beacon receiver in transponder terminals are performed by the modem instead. EHF downlink synchronization hops substitute for the downlink beacon on a transponder satellite and signal level estimates made by the modern from sync hops substitute for the output of a beacon receiver in the spatial acquisition and tracking processes. EHF spatial acquisition is more complicated since it is usually combined with a time search performed by the modem and hence requires coordination between the modem and the antenna control unit managed at the terminal control level. The parameters of this combined time and spatial search are typically optimized for a particular terminal, taking into account the maximum time error, the maximum pointing error contributed by all sources, and antenna characteristics including beamwidth and slew rate. Additionally, signal fading and outages typical of on-the-move operation must also be considered. Such optimization of the time and spatial search algorithms for EHF acquisition is commonly used today and is thus well within the skill of one of ordinary skill in the art and are not discussed further.

To maximize EHF modem software and hardware commonality among different terminal types, and thus reduced development and deployment costs, the functional partitioning and interface definition between antenna control unit 270 and the EHF modem 262 should make the modem independent of the antenna type and installation details. According to one embodiment of the present invention, the functional partitioning thus allocates all antenna-type specific tasks to antenna control unit 270 and all waveform specific tasks to EHF modern 262. The goal is to allow different antenna types to be integrated with the same type of EHF modem without requiring changes in modem functions or interfaces. Accordingly, according to one embodiment of the present invention, the functional partitioning may be performed as follows:
Pointing—Operator interface 203 provides a pointing vector in earth coordinates; antenna control unit 270 performs the translations that account for installation and array orientation.
Tracking—Modern 262 provides unprocessed signal and noise estimates derived from sync hops; antenna control unit 270 performs the tracking algorithm
Stabilization—Antenna control unit 270 is solely responsible to compensate for platform motion

Based on this functional partitioning, EHF modem 262 provides (in this exemplary embodiment) the following information to antenna control unit 270:
Unfiltered Received Signal Level (RSL) measurements, two per sync hop
Noise Level measurement
Sync Hop Indication
Uplink and Downlink Hop Timing Synchronization
Uplink and Downlink Hop Frequencies

First half hop and second half hop RSL measurements are included in the interface to support electronic scan for spatial tracking as described above. The modem also provides hop frequencies to the antenna system to allow for compensation of the beam squint that occurs over the frequency hopping band.

In some embodiments, ACU 270 operates under the control of antenna control software residing on a single board computer within ACU 270. This software may run, in one exemplary embodiment, on an embedded real-time operating system (RTOS), such as (but not limited to) the VxWorks® RTOS from Wind River Systems, Inc. of Alameda, Calif. The user interface used for monitor and control of ACU 270 may be served as a Java Applet that can be accessed from a compatible web browser running on operator interface 203 and connected to ACU 270 via Ethernet. Alternatively, a conventional SNMP interface can also be used for monitor and control over standard internetworking methods such as the well-known Ethernet or equivalents. Although a particular software and hardware platform for hoisting the antenna control software and/or user interface 203 is described in connection with this exemplary embodiment, those skilled in the art will realize that other platforms can be used. Accordingly, the concepts, systems, and techniques described herein are not limited to any particular type of hardware of software platform.

General antenna control software functions include, inter alfa, computing antenna pointing angles in North-East-Down (NED) coordinates using the terminal's location (via GPS) and either satellite ephemeris or operator-entered satellite coordinates and transforming the NED coordinates to positions commands for the turntable and the beam control electronics discussed above. (It will be recalled that the beam control electronics may be implemented solely within ACU 270 or distributed among ACU 270 and BSCs within each AESA, as exemplified in FIG. 4, without limitation.) Transformation of the NED coordinates may be performed using vehicle heading, pitch and roll provided by INS system 475.

Other general antenna control software functions include: driving the turntable servo motor 473 to the correct angular position using conventional angular rate and position feedback information from the antenna pedestal while providing pointing angles in the antennas' local coordinate system to the beam control electronics; providing a digital word representing a quantized version of the operating frequency to the beam control electronics for use in pointing the beam; interfacing with a laptop computer used as operator interface 203; and performing on-line and off-line fault isolation of the entire antenna system.

The ACU 270 accepts user interface 203 or SNMP commands, and routes them to the appropriate destination module/component of the system. A conventional Mode Control software module, of a type and construction familiar to one of ordinary skill in the art, may be employed to control the overall state of the ACU (or beam control electronics in general), and handles startup, acquisition, and track sequencing based on system state and commands. An Antenna Control software module, also of a type and construction familiar to one of ordinary skill in the art, may be employed to collect current information from various hardware devices, perform calculations to control the turntable, and command the beam control electronics to point at the desired location.

In an exemplary embodiment, the beam control electronics in general, and ACU 270 specifically, may maintain several databases stored in NVRAM, including Two Line Element (TLE) ephemeris sets, current state information, and adaptation data. The TLE sets can be downloaded to the ACU from user interface 203 and chosen at acquisition time. The State Database preserves key information through power cycles and allow for autonomous acquisition based on previous settings. Adaptation data holds information unique to the installation such as calibration data and offsets.

As noted above, operator interface 203 may be implemented on a conventional laptop PC that interfaces with ACU 270 and/or the beam control electronics in general. A conventional Graphical User Interface (GUI) resident in and running on operator interface 203 may provide the capability to control and monitor the antenna system configuration and performance. Operational software may also reside, in some embodiments, on a single board computer within the ACU 270. Operator interface 203, further equipped with a conventional web browser, may use hypertext markup language (HTML) to invoke the operational software, which may (in some exemplary embodiments) be written in Java.

Standard CD/DVD and/or USB port interfaces on operator interface 203 may be used to load configuration files and software, including but not limited to the satellite ephemeris and the operational and GUI software, into the system. A conventional computer interface between the laptop computer and the ACU 270, for example, may allow the loading of operational antenna control and GUI software to the ACU and access to the GUI from the ACU.

The basic operational capabilities provided by the system include a password protected operator logon. This feature allows only authorized download of ACU software and ephemeris data sets and operational control of the antenna system. The capability to manage the download and usage of the software and data sets is included as is the capability to configure the antenna system for operation through the selection of a satellite and a waveform. Additional capabilities may include, without limitation, the following:
Select acquisition mode (Automatic, Manual)
Control acquisition (Start, Stop)
Select tracking mode (Automatic, Manual)
Control tracking (Start, Stop)
Point manually to a satellite (either 1-degree or 0.1-degree steps)
Display status—system state, terminal location, pointing angles and transmitter state

In some embodiments, the vehicle or platform may supply standard, commonly-employed 28 VDC, MIL-STD-1275 compliant power to run the electronics within the azimuth turntable (including the antennas and associated electronics) as well as electronics outside of the azimuth turntable. For the electronics at the antennas, the power is routed via the azimuth turntable slip rings and processed to supply the desired voltages. For electrical components below the slip rings, the power is input directly to filtering and conversion modules to obtain the desired voltages.

### Alternate Embodiments

Although a satellite in a geosynchronous orbit is described, those skilled in the art will realize that communications with satellites in orbits other than a geosynchronous (for example, but without limitation, low earth, elliptical, or sun-synchronous [Molniya]) orbits can be accomplished with the present system. Accordingly, the concepts, systems, and techniques described herein are not limited to any particular type of orbit.

It should also be noted that reference is sometimes made herein to an antenna having a particular array shape and/or physical size or a particular number of antenna elements. One of ordinary skill in the art will appreciate that the techniques described herein are applicable to various sizes and shapes of antennas and/or arrays and that any number of antenna elements may be used.

The techniques and systems of the present invention may be implemented in whole or in part with either hardware, software, or any combination thereof, as those terms are currently known in the art. In particular, the present system may be implemented by software, firmware, and/or microcode operating on a computer or computers of any type. Additionally, software embodying all or part of the present invention may comprise computer instructions in any form (e.g., source code, object code, and/or interpreted code, etc.) stored in any computer-readable medium (e.g., ROM, RAM, magnetic media, punched tape or card, compact disc (CD), and/or digital versatile disc (DVD), etc.). Furthermore, such software may also be in the form of a non-transitory computer data signal embodied in a carrier wave, such as that found within the well-known Web pages transferred among devices connected to and with computer networks, such as the Internet. Accordingly, the present invention is not limited to any particular platform, unless specifically stated otherwise in the present disclosure.

While particular embodiments of the present invention have been shown and described, it will he apparent to those skilled in the art that various changes and modifications in form and details may be made therein without departing from the spirit and scope of the invention as defined by the following claims. Accordingly, the appended claims encompass within their scope all such changes and modifications.

We claim:

1. An apparatus for communications on the move, comprising:
a plurality of electronically-steered Active Electronically Scanned Arrays (AESAs) disposed on a mechanically-steered mounting platform, wherein said plurality of AESAs are located with respect to one another so as to minimize self-interference, each of said plurality of AESAs having a main beam lobe;
frequency conversion electronics operably connected to each of said antenna modules; and
beam control electronics operably connected to said mechanically-steered mounting platform, said frequency conversion electronics, and to each of said plurality of AESAs,
wherein said mechanically-steered mounting platform is controlled by said beam control electronics to maintain directional pointing control to an azimuth selected with respect to a line-of-sight to a geosynchronous satellite; and
wherein each of said plurality of AESAs is electronically steered to maintain their respective main beam lobes essentially perpendicular to the geosynchronous orbital arc at the location of the geosynchronous satellite.

2. The apparatus of claim 1, further comprising an inertial navigation system operatively coupled to said beam control electronics.

3. The apparatus of claim 1, wherein one or more of the plurality of AESAs is a K-band receive AESA.

4. The apparatus of claim 1, wherein one or more of the plurality of AESAs is a Ka-band transmit AESA.

5. The apparatus of claim 1, wherein one or more of the plurality of AESAs is a Q-band transmit AESA.

6. The apparatus of claim 1, wherein said beam control electronics further comprise:
an antenna control unit (ACU), the ACU further comprising a programmed computer;
one or more beam steering controllers, each operatively coupled to the ACU; and
a mechanically-steered pedestal azimuth control means operatively coupled to the ACU.

7. The apparatus of claim 1, wherein at least one of said plurality of AESAs are selectable between RHCP and LHCP.

8. The apparatus of claim 1, further comprising a beacon tracker operatively coupled to said beam control electronics, wherein the beacon tracker provides closed-loop tracking of a transponder signal.

9. The apparatus of claim 1, further comprising modem tracking means operatively coupled to said beam control electronics and said frequency conversion electronics, wherein the modem tracking means provides closed-loop tracking of a received signal.
